(19) United States
(12) Patent Application Publication
(10) Pub. No.: US 2026/0357961 A1
(43) Pub. Date: Nov. 12, 2026

(54) DEVELOPMENT OF A HYBRID SUN/LED LIGHTING SYSTEM-BASED MULTIMODE FIBER OPTICS (HSLM-FO)

(71) Applicant: IMAM ABDULRAHMAN BIN FAISAL UNIVERSITY, Dammam (SA)

(72) Inventors: Taher Saleh MAATALLAH, Dammam (SA); Mussad Mohammed AL-ZAHRANI, Dammam (SA); Ahmad Mohammed ALMATAR, Dhahran (SA); Faisal Mohammad WAHAB, Dammam (SA)

(73) Assignee: IMAM ABDULRAHMAN BIN FAISAL UNIVERSITY, Dammam (SA)

(21) Appl. No.: 19/200,857

(22) Filed: May 7, 2025

(51) Int. Cl. F21S 11/00

(52) U.S. Cl. CPC F21S 11/002; F21S 11/007

(57) ABSTRACT

A system for sunlight redistribution includes a light concentrating Fresnel lens configured to direct light to an infrared filter disposed above a plano-concave lens. The plano-concave lens is disposed above a fiber optic bundle comprising a plurality of optical fibers with an exterior end and an interior end. The system also includes a distributing lens disposed below the fiber optic bundle for transferring and distributing visible light to an interior space. The exterior end receives visible light from the plano-concave lens and the interior end transmits visible light to the distributing lens. The optical fibers include a core material and cladding material with a specified refractive index ratio. The system further includes a heat sink surrounding the exterior end of the fiber optic bundle and a sensor for detecting ambient light levels, enabling automated supplementary illumination control.

### BACKGROUND

### Technical Field

The present disclosure relates generally to the field of lighting systems, and more particularly to systems and methods for natural sunlight redistribution utilizing fiber optic technology in combination with artificial lighting capabilities.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present disclosure.

Interior spaces in modern buildings frequently lack access to natural sunlight, necessitating continuous artificial lighting solutions. Conventional lighting systems predominantly rely on grid-connected, heat-generating devices that consume large amounts of electrical energy. Fiber Optic Daylighting system (FOD) represents a promising waveguide technology that effectively transmits sunlight inside interior windowless spaces and buildings. While conventional lighting solutions are predominantly heat-based and integrated-grid devices, FOD contributes to enhanced energy savings through natural sunlight transmission and can be coupled to a Light Emitting Diode system to provide increased reliability [See: Ullah, I., et al., Development of Optical Fiber-based Daylighting System with Uniform Illumination, J. Opt. Soc. Korea, 16, 247-255, 2012; Ullah, I., et al., Development of Optical Fiber-Based Daylighting System and Its Comparison, Energies, 2015, 8, 7185-7201].

Fiber optics facilitate light transfer utilizing the principle of Total Internal Reflection (TIR), in which light is transmitted through the core of the fiber by bouncing off the walls due to the difference in refractive indices of the core and cladding [See: Dutta, M, Maximizing the Benefits of Daylight in Residential Design and Construction: A Review of Modern Homes and Villas, Studies in Art and Architecture, 2, 1, 16-20, 2023; Štochl, N., et al., Illumination of Interior Spaces through Structures Made of Unified Slabs of High-Performance Light-Transmitting Concrete with Embedded Optical Fibers, Materials, 16, 8, 3142, 2023; Stem Cell Research International, Fiber Technology and Its Application in the Modern Society, Stem Cell Research International, 5, 1, 2023; Zanoon, N., The Phenomenon of Total Internal Reflection and Acceleration of Light in Fiber Optics, International Journal of Computer Applications, 107, 2, 19-24, 2014; Fenta, M., et al., Fibre Optic Methods of Prospecting: A Comprehensive and Modern Branch of Geophysics, Surveys in Geophysics, 42, 3, 551-584, 2021].

Effective light transmission in FOD systems requires precise alignment between incoming sunlight and the fiber optic's numerical aperture. Only sunlight beams that intercept the inlet aperture area of the fiber optics with an incident angle lesser than the breadth-extent or the numerical aperture of the fiber optics are effectively transmitted throughout the FOD. Consequently, imaging sunlight concentrators, such as parabolic dishes, parabolic troughs and Fresnel Lenses demonstrate enhanced efficiency in achieving optimal transmission efficiencies [See: Iqbal, W., et al., Optical Developments in Concentrator Photovoltaic Systems—A Review, Sustainability, 15, 13, 10554, 2023; Ullah, I, Fiber-based daylighting system using trough collector for uniform illumination, Solar Energy, 196, 484-493, 2020], as these components produce higher sun irradiations onto small sunspot size through specular reflection or refraction processes.

However, existing FOD systems face several technical challenges, including thermal management issues, transmission efficiency limitations, and the inability to provide consistent illumination during periods of insufficient natural light. Additionally, current systems often lack precise optical component positioning and integrated thermal management solutions. Some solutions have been implemented for achieving uniform daylight distribution at the capturing stage. Further, some solutions have been implemented for managing thermal loads. These known solutions have been discussed hereinafter.

JP2014035358A describes an optical fiber lighting device incorporating an infrared reflection function film bonded to the upper end of optical fibers via adhesive, designed to cut infrared components from sunlight before entering the optical fiber. The system utilizes a Fresnel lens for light concentration and includes fiber optic elements with specific core-cladding configurations. However, this reference does not describe a combination of a light concentrating Fresnel lens, an infrared filter, a plano-concave lens and a distributing lens with precise component positioning for sunlight redistribution, while managing thermal loads effectively and resulting in consistent illumination during periods of varying natural light availability.

U.S. Pat. No. 4,539,625A discloses a combined lighting system utilizing luminescent solar concentrators with optical fiber bundles for daylight transmission, incorporating a collimating lens and artificial light source. The system includes a daylight sensor coupled to an automatic dimmer/brightener unit for maintaining constant illumination levels. However, this reference does not describe a combination of a light concentrating Fresnel lens, an infrared filter, a plano-concave lens and a distributing lens with precise component positioning for sunlight redistribution, while managing thermal loads effectively and resulting in consistent illumination during periods of varying natural light availability.

U.S. Pat. No. 4,026,267A describes a solar energy apparatus utilizing wide-angle lens components to focus solar radiation onto an optical fiber bundle end, with the opposite end positioned in an energy storage area. The system incorporates a heat sink for thermal management of collected solar energy. However, this reference does not describe a combination of a light concentrating Fresnel lens, an infrared filter, a plano-concave lens and a distributing lens with precise component positioning for sunlight redistribution, while managing thermal loads effectively and resulting in consistent illumination during periods of varying natural light availability.

CN105222076A presents a solar tracking light-transmission lighting device combining sun viewing movement locus tracking and photoelectric tracking methods. The system employs a Fresnel lens, converging lens group, and light-guiding optical fibers with integrated filtering capabilities. However, this reference does not describe a combination of a light concentrating Fresnel lens, an infrared filter, a plano-concave lens and a distributing lens with precise component positioning for sunlight redistribution, while managing thermal loads effectively and resulting in consistent illumination during periods of varying natural light availability.

Each of the aforementioned references suffers from one or more drawbacks hindering their adoption, such as thermal management inefficiencies, limited transmission capabilities, suboptimal component positioning, inadequate spectral filtering, and insufficient integration between natural and artificial lighting sources. The complexity of precise optical alignment, coupled with challenges in managing infrared radiation and maintaining optimal refractive index ratios, has limited the widespread implementation of fiber optic daylighting solutions. Additionally, current approaches frequently lack comprehensive solutions for uniform light distribution and efficient thermal dissipation, particularly in applications requiring sustained high-intensity light transmission. Accordingly, it is one object of the present disclosure to provide a system for sunlight redistribution that addresses these limitations through strategic component integration and optimized optical design parameters, effectively combining natural sunlight transmission capabilities with supplementary artificial lighting while maintaining optimal thermal characteristics and transmission efficiency.

### SUMMARY

In an aspect, a system for sunlight redistribution comprising: a light concentrating Fresnel lens configured to direct light to an infrared filter; the infrared filter disposed above a plano-concave lens; the plano-concave lens disposed above a fiber optic bundle comprising a plurality of optical fibers, an exterior end, and an interior end; a distributing lens disposed below the fiber optic bundle which transfers visible light to; and the distributing lens which distributes visible light to an interior space, wherein the exterior end receives visible light from the plano-concave lens and the interior end transmits visible light to the distributing lens, wherein the optical fibers comprise a core material and cladding material, wherein the refractive index ratio of the core material to cladding material is in a range from 1.05 to 1.075, wherein the infrared filter is positioned 403 to 413 mm from the Fresnel lens, wherein the plano-concave lens is positioned 428 to 438 mm from the Fresnel lens, and wherein the exterior end of the fiber optic bundle is positioned 458 to 468 mm from the Fresnel lens.

In some embodiments, the Fresnel lens has a diameter in a range from 340 to 360 mm.

In some embodiments, the Fresnel lens has a diameter in a range from 345 to 355 mm.

In some embodiments, the Fresnel lens has a diameter of 350 mm.

In some embodiments, the infrared filter has a diameter in a range from 45 to 55 mm.

In some embodiments, the infrared filter has a diameter in a range from 47 to 53 mm.

In some embodiments, the infrared filter has a diameter of 50 mm.

In some embodiments, the plano-concave lens has a diameter in a range from 27 to 33 mm.

In some embodiments, the plano-concave lens has a diameter in a range from 29 to 31 mm.

In some embodiments, the plano-concave lens has a diameter of 30 mm.

In some embodiments, the fiber optic bundle has a diameter in a range from 27 to 33 mm.

In some embodiments, the fiber optic bundle has a diameter in a range from 29 to 31 mm.

In some embodiments, the fiber optic bundle has a diameter of 30 mm.

In some embodiments, the infrared filter is positioned 408 mm from the Fresnel lens.

In some embodiments, the plano-concave lens is positioned 433 mm from the Fresnel lens.

In some embodiments, the fiber optic bundle is positioned 460 to 466 mm from the Fresnel lens.

In some embodiments, the fiber optic bundle is positioned 463 mm from the Fresnel lens.

In some embodiments, the system further comprises a sensor which detects ambient light levels.

In some embodiments, the system further comprises a heat sink surrounding the exterior end of the fiber optic bundle.

In some embodiments, the core material is polymethyl methacrylate and the cladding material is a fluoropolymer.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings.

FIG. 1 is an exemplary perspective diagram of a system for sunlight redistribution, according to certain embodiments.

FIG. 2A is an exemplary exploded diagram of an optical system of the system for sunlight redistribution of FIG. 1, according to certain embodiments.

FIG. 2B is an exemplary schematic diagram of the optical system of FIG. 2A, according to certain embodiments.

FIG. 3A is an exemplary side perspective diagram of a Fresnel lens of the optical system, according to certain embodiments.

FIG. 3B is an exemplary top planar diagram of the Fresnel lens of FIG. 3A, according to certain embodiments.

FIG. 4A is an exemplary side perspective diagram of an infrared filter of the optical system, according to certain embodiments.

FIG. 4B is an exemplary top planar diagram of the infrared filter of FIG. 4A, according to certain embodiments.

FIG. 5A is an exemplary side perspective diagram of a plano-concave lens of the optical system, according to certain embodiments.

FIG. 5B is an exemplary top planar diagram of the plano-concave lens of FIG. 5A, according to certain embodiments.

FIG. 6A is an exemplary side perspective diagram of a fiber optic bundle, being surrounded by a heat sink, of the optical system, according to certain embodiments.

FIG. 6B is an exemplary top planar diagram of the fiber optic bundle with the heat sink of FIG. 6A, according to certain embodiments.

FIG. 7A is an exemplary perspective diagram of a supporting frame of the system for sunlight redistribution, according to certain embodiments.

FIG. 7B is an exemplary side planar diagram of the supporting frame of FIG. 7A, according to certain embodiments.

FIG. 7C is an exemplary back planar diagram of the supporting frame of FIG. 7A, according to certain embodiments.

FIG. 7D is an exemplary top planar diagram of the supporting frame of FIG. 7A, according to certain embodiments.

FIG. 8 is an exemplary flow chart illustrating an operation of the system for sunlight redistribution, according to certain embodiments.

FIG. 9A is an exemplary diagram illustrating transmission of light in the system, showing a complete system view with a gradient visualization demonstrating the progressive concentration of light from the Fresnel lens through the optical components, according to certain embodiments.

FIG. 9B is an exemplary diagram illustrating transmission of light in the system, showing the light concentration pathway depicted by the conical gradient from the Fresnel lens through the optical components.

FIG. 9C is an exemplary diagram illustrating transmission of light in the system, showing a cross-sectional view of the fiber optic bundle with the transmission path of light through the exterior portion.

FIG. 9D is an exemplary diagram illustrating transmission of light in the system, showing a detailed view of a single optical fiber within the bundle, demonstrating the internal light propagation characteristics.

FIG. 10 is an exemplary diagram illustrating optical boundary conditions for the system for sunlight redistribution, according to certain embodiments.

FIG. 11 is an exemplary diagram illustrating thermal boundary conditions for the system for sunlight redistribution, according to certain embodiments.

FIG. 12 is an illustration of a non-limiting example of details of computing hardware used in the computing system, according to certain embodiments.

FIG. 13 is an exemplary schematic diagram of a data processing system used within the computing system, according to certain embodiments.

FIG. 14 is an exemplary schematic diagram of a processor used with the computing system, according to certain embodiments.

FIG. 15 is an illustration of a non-limiting example of distributed components which may share processing with the controller, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

Aspects of this disclosure are directed to a system for sunlight redistribution that integrates advanced optical concentration, spectral filtering, and light transmission technologies into a unified architecture. The system incorporates optical pathways designed to maximize light capture efficiency while minimizing thermal loading and transmission losses. The system of the present disclosure achieves enhanced light transmission characteristics through strategic positioning of optical components and careful material selection. The system further integrates supplementary illumination capabilities to provide consistent performance across varying environmental conditions, while thermal management features protect system components during sustained operation.

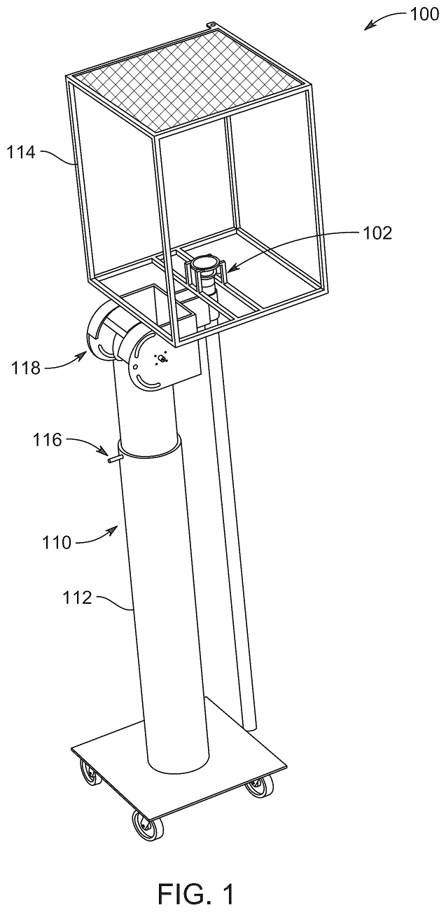

FIG. 1 illustrates an exemplary schematic diagram of a system (as represented by reference numeral 100) for sunlight redistribution, as per embodiments of the present disclosure. The system 100 provides a solution to natural light redistribution, combining multiple technological innovations to address the challenges of interior daylighting. The system 100 employs a multi-stage light processing architecture that systematically addresses the limitations of conventional approaches. The system 100 includes an optical assembly 102 integrating multiple optical components in a precisely configured arrangement to achieve efficient sunlight capture, transmission, and distribution for interior lighting applications. The system 100 of the present disclosure has design features facilitating deployment across diverse architectural environments, particularly in applications requiring high-intensity light transmission over extended distances, enabling applications ranging from commercial office spaces to industrial facilities.

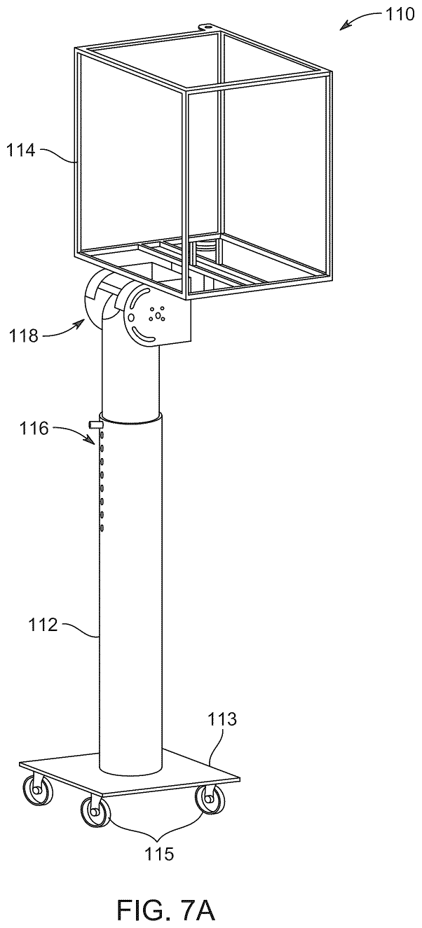

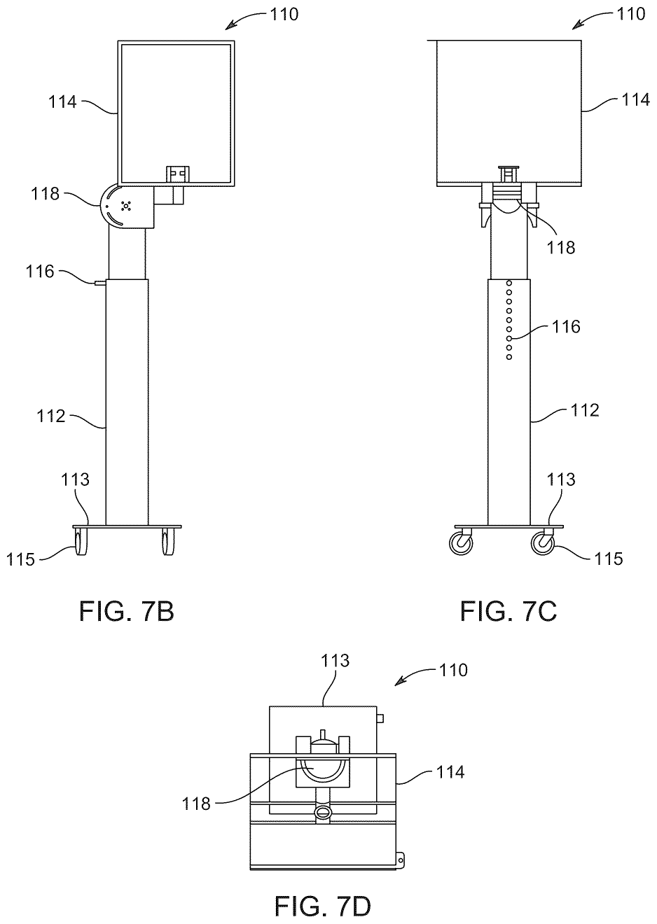

As illustrated in FIG. 1, the system 100 includes a support frame 110 that houses and support the optical assembly 102 thereof in a specific geometric configuration. The support frame 110 includes a vertical support member 112 which supports various components including the optical assembly 102 with the optical components of the system 100. The support frame 110 further includes a mounting platform 114 configured to mount and maintain optical alignment of the optical components in the optical assembly 102, during operation of the system 100. The support frame 110 may be provided with an adjustable height mechanism 116 to allow for vertical adjustment of the optical assembly 102, and a tilting mechanism 118 to allow for angular adjustment of the optical assembly 102. In some examples, the support frame 110 may incorporate stabilizing elements to minimize vibration effects on the optical assembly 102 to provide consistent performance under varying environmental conditions. Further, details of the support frame 110 have been discussed later in reference to FIGS. 7A-7D.

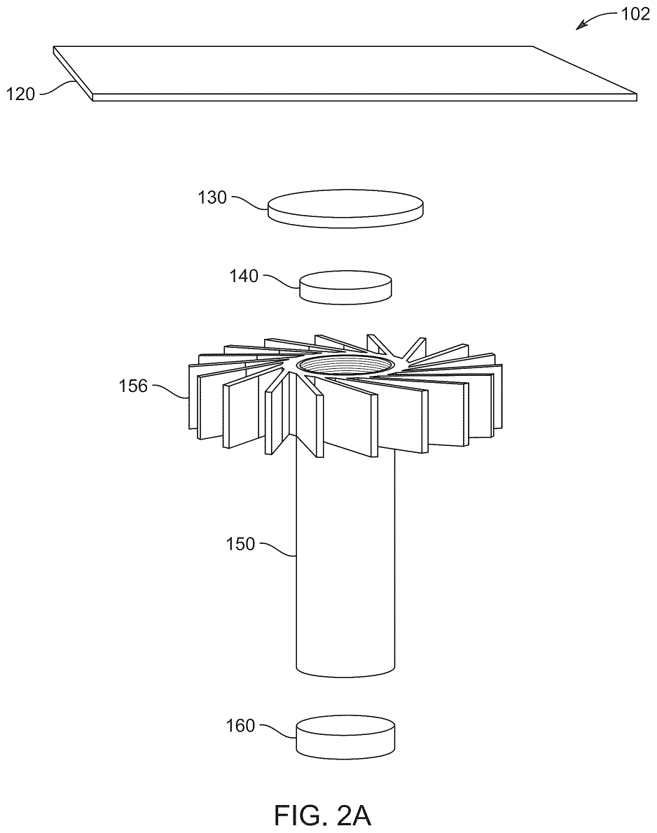

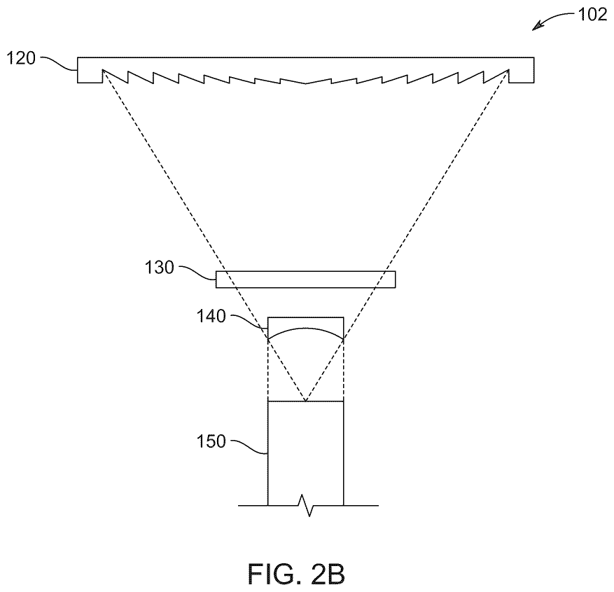

Referring now to FIGS. 2A and 2B in combination, illustrated are different views of the optical assembly 102. As shown, the optical assembly 102, in the system 100, includes a light concentrating Fresnel lens 120, an infrared filter 130, a plano-concave lens 140, and a fiber optic bundle 150. In the present configuration, the optical assembly 102 implements a multi-stage light processing configuration, in which each optical component is positioned at specific predetermined distances relative to adjacent components to achieve optimal light transmission characteristics. The geometric arrangement of components within the optical assembly 102 facilitates sequential processing of incident light through concentration, spectral filtering, beam shaping, and transmission stages, with precise alignment maintained through mechanical interfaces within the support frame 110.

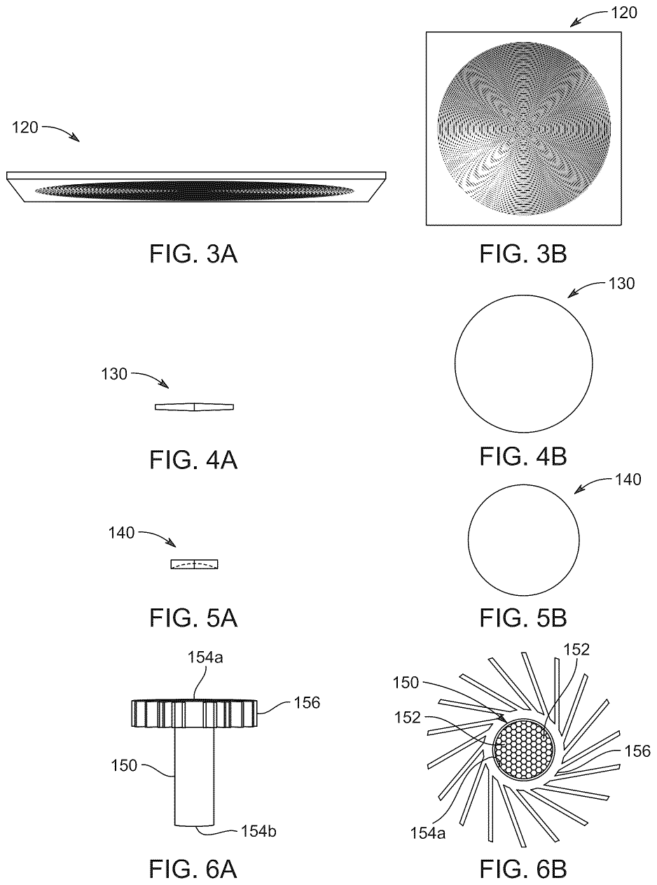

FIGS. 3A and 3B illustrate detailed views of the Fresnel lens 120. In the optical assembly 102, the Fresnel lens 120 acts as the primary optical element, positioned at the uppermost section of the optical pathway. The Fresnel lens 120 features a series of concentric grooves precisely machined to achieve optimal light concentration characteristics. In the optical assembly 102, the light concentrating Fresnel lens 120 is configured to direct light to the infrared filter 130. The Fresnel lens 120 is specifically designed to concentrate incident sunlight and direct it toward the infrared filter 130 positioned below, maintaining optical alignment through the support frame 110. In an embodiment, the Fresnel lens 120 has a diameter in a range from 330 to 370 millimeters (mm), preferably 340 to 360 mm. In a specific embodiment, the Fresnel lens 120 has a diameter in a range from 345 to 355 mm. In a preferred embodiment, the Fresnel lens has a diameter of 350 mm.

FIGS. 4A and 4B illustrate detailed views of the infrared filter 130. In the optical assembly 102, the infrared filter 130 is disposed above the plano-concave lens 140. In present embodiments, the infrared filter 130 is positioned 393 to 423 mm, preferably 403 to 413 mm from the Fresnel lens 120. In a specific embodiment, the infrared filter 130 is positioned 408 mm from the Fresnel lens 120. That is, in general, the infrared filter 130 is positioned at a specific distance range of 403 to 413 millimeters from the Fresnel lens 120, with optimal positioning at 408 millimeters. The infrared filter 130 is configured to selectively transmit visible light while blocking infrared radiation. This selective filtering capability protects downstream optical components from thermal damage while maintaining efficient visible light transmission. The infrared filter 130 is precisely aligned above the plano-concave lens 140, creating an optimized optical pathway for concentrated visible light transmission. In an embodiment, the infrared filter 130 has a diameter in a range from 35 to 65 mm, preferably 45 to 55 mm. In a specific embodiment, the infrared filter 130 has a diameter in a range from 47 to 53 mm. In a preferred embodiment, the infrared filter 130 has a diameter of 50 mm.

FIGS. 5A and 5B illustrate detailed views of the plano-concave lens 140. In the optical assembly 102, the plano-concave lens 140 is disposed above the fiber optic bundle 150 comprising a plurality of optical fibers 152, an exterior end 154a, and an interior end 154b. In present embodiments, the plano-concave lens 140 is positioned 418 to 448 mm, preferably 428 to 438 mm from the Fresnel lens 120. In a specific embodiment, the plano-concave lens 140 is positioned 433 mm from the Fresnel lens 120. That is, in general, the plano-concave lens 140 is positioned at a distance of 428 to 438 millimeters from the Fresnel lens 120, with optimal positioning at 433 millimeters. The plano-concave lens 140 is configured to optimize the incident angle of concentrated light for transmission through the fiber optic bundle 150. The plano-concave lens 140 maintains precise optical alignment with both the infrared filter 130 above and the fiber optic bundle 150 below through the support frame 110. In an embodiment, the plano-concave lens 140 has a diameter in a range from 20 to 40 mm, preferably 27 to 33 mm. In a specific embodiment, the plano-concave lens 140 has a diameter in a range from 29 to 31 mm. In a preferred embodiment, the plano-concave lens 140 has a diameter of 30 mm.

FIGS. 6A and 6B illustrate detailed views of the fiber optic bundle 150. Herein, the fiber optic bundle 150 includes the plurality of optical fibers 152 configured in a cylindrical arrangement with a diameter matching that of the plano-concave lens 140, ranging from 20 to 40 mm, preferably 27 to 33 millimeters, preferably 30 millimeters. The fiber optic bundle 150 has the exterior end 154a positioned to receive visible light from the plano-concave lens 140, and the interior end 154b configured to transmit the visible light to the interior space. In present embodiments, the exterior end 154a of the fiber optic bundle 150 is positioned 448 to 478 mm, preferably 458 to 468 mm from the Fresnel lens 120. In a specific embodiment, the fiber optic bundle 150 is positioned 460 to 466 mm from the Fresnel lens 120. In a preferred embodiment, the fiber optic bundle 150 is positioned 463 mm from the Fresnel lens 120. That is, in general, the exterior end 154a of the fiber optic bundle 150 is positioned at a distance of 458 to 468 millimeters from the Fresnel lens 120, with optimal positioning at 463 millimeters, corresponding to the focal length of the Fresnel lens 120. In an embodiment, the fiber optic bundle 150 has a diameter in a range from 20 to 40 mm, preferably 27 to 33 mm. In a specific embodiment, the fiber optic bundle 150 has a diameter in a range from 29 to 31 mm. In a preferred embodiment, the fiber optic bundle 150 has a diameter of 30 mm.

Further, as illustrated, the system 100 further comprises a heat sink 156 surrounding the exterior end 154a of the fiber optic bundle 150. The system 100 incorporates advanced thermal management through implementation of the heat sink 156 surrounding the exterior end 154a of the fiber optic bundle 150. In an example configuration, the heat sink 156 is constructed from aluminum alloy 6060, selected for optimal thermal conductivity (200 W/m·K) and mechanical stability. The circular configuration of the heat sink 156 provides uniform thermal dissipation around the circumference of the fiber optic bundle 150, maintaining operational temperatures within specified parameters. A thermal interface material, specifically DOWSIL™ TC-4060 silicone thermal gel with thermal conductivity of 6 W/m·K, is applied between the fiber optic bundle 150 and the heat sink 156 to enhance thermal transfer efficiency.

The heat sink 156 features optimized fin geometry designed through computational fluid dynamics analysis to maximize convective heat transfer while minimizing material usage. The thermal management system maintains temperatures of the fiber optic bundle 150 below defined thresholds during periods of maximum solar concentration, preventing thermal degradation of optical properties and leading to sustained transmission efficiency. The heat sink 156 enables the system 100 to operate continuously under peak solar conditions while maintaining thermal stability of all optical components.

Further, as illustrated, the optical assembly 102 includes a distributing lens 160 disposed below the fiber optic bundle 150 which transfers and distributes visible light to an interior space. The distributing lens 160 is positioned below the interior end 154b of the fiber optic bundle 150 and is specifically configured to receive transmitted visible light from the fiber optic bundle 150 and distribute the received light uniformly throughout the interior space. The distributing lens 160 incorporates optical geometries optimized for even light distribution while minimizing transmission losses. In present configuration, the distributing lens 160 may maintain optical alignment with the fiber optic bundle 150 through mechanical coupling with the support frame 110, providing consistent illumination characteristics.

Herein, the exterior end 154a receives visible light from the plano-concave lens 140 and the interior end 154b transmits visible light to the distributing lens 160. The optical pathway within the system 100 maintains continuous transmission through optical alignment of components. The exterior end 154a of the fiber optic bundle 150 is positioned and oriented to receive collimated visible light from the plano-concave lens 140 at an optimal incident angle to maximize transmission efficiency. The interior end 154b of the fiber optic bundle 150 maintains precise alignment with the distributing lens 160 to provide efficient light transfer and uniform distribution characteristics.

In the present embodiments, the optical fibers 152 comprise a core material and cladding material. Further, the refractive index ratio of the core material to cladding material is in a range from 1.01 to 1.115, preferably 1.05 to 1.075. That is, the plurality of optical fibers 152 within the fiber optic bundle 150 feature a dual-material construction configured for optimal light transmission. In an embodiment, the core material is polymethyl methacrylate and the cladding material is a fluoropolymer. Each fiber comprises a core material composed of polymethyl methacrylate (PMMA) with a controlled refractive index, surrounded by a cladding material composed of fluoropolymer. The refractive index ratio between core and cladding materials is maintained within the range of 1.01 to 1.115, preferably 1.05 to 1.075, enabling efficient total internal reflection while minimizing transmission losses. This specific ratio range optimizes the numerical aperture of the optical fibers 152 while maintaining mechanical and thermal stability during operation.

The optical assembly 102 operates through coordinated interaction between optical components to process incident sunlight for interior space illumination. Sunlight entering the optical assembly 102 undergoes concentration through the Fresnel lens 120, followed by infrared radiation removal via the infrared filter 130. The processed light beam then passes through the plano-concave lens 140 for beam profile optimization before entering the fiber optic bundle 150. The fiber optic bundle 150 facilitates light transmission to the distributing lens 160, which distribute it uniformly throughout the target interior space. The heat sink 156 surrounding the fiber optic bundle 150 provides thermal management. Each component interface within the optical assembly 102 maintains specific dimensional relationships, as measured from the Fresnel lens 120, to provide efficient light transfer through the system 100. The configuration of the optical assembly 102 enables controlled light transmission while minimizing thermal loading and maintaining operational stability across varying environmental conditions.

Referring now to FIGS. 7A-7D, illustrated are multiple views of the support frame 110 of the system 100. FIG. 7A shows a perspective view of the support frame 110 comprising the vertical support member 112 mounted on a base platform 113 with integrated caster wheels 115 for mobility. The vertical support member 112 incorporates the adjustable height mechanism 116 configured with vertical adjustment capabilities through a series of indexed positions. The mounting platform 114 is attached to the upper portion of vertical support member 112 through the tilting mechanism 118, enabling angular adjustment of the optical assembly 102 relative to the vertical axis for optimal solar tracking.

FIGS. 7B and 7C illustrate side and back planar views respectively of the support frame 110, illustrating the geometric relationships between the vertical support member 112 and the mounting platform 114. The tilting mechanism 118 enables rotation of the mounting platform 114 through a range of 0-45 degrees relative to horizontal, with integrated locking mechanisms at 5-degree increments. FIG. 7D provides a top planar view of the mounting interface between the tilting mechanism 118 and the mounting platform 114, detailing the mechanical coupling that maintains rigid positioning of optical assembly 102 while enabling precise angular adjustments. As discussed, the mounting platform 114 may incorporate vibration dampening elements at interface points with optical assembly 102, providing stable optical alignment under dynamic environmental conditions.

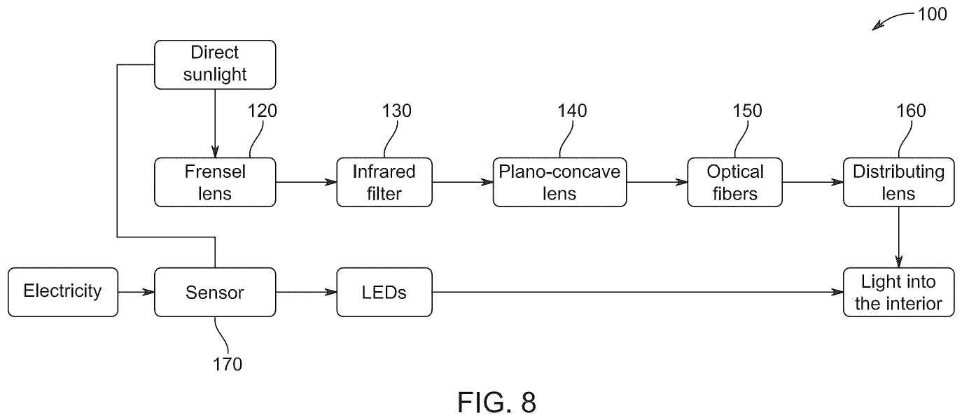

The system 100 may further incorporate supplementary features for enhanced operational performance. In an embodiment, as illustrated in FIG. 8, the system 100 further includes a sensor 170 which detects ambient light levels. The sensor 170 employs high-precision photoelectric elements configured to measure illuminance levels across the visible spectrum (380-780 nm wavelength range). The sensor 170 provides continuous monitoring of natural light availability, enabling automated control of supplementary LED illumination to maintain consistent lighting levels in the interior space (as targeted). The sensor 170 interfaces with an electronic controller that processes illumination data, providing real-time response to variations in natural light availability. This integration enables the system 100 to maintain uniform illumination levels through automated adjustment of artificial light sources during periods of insufficient natural light transmission.

FIG. 8 illustrates the operational process flow of the system 100, depicting both natural and artificial lighting pathways. In the natural lighting pathway, direct sunlight enters the Fresnel lens 120 serving as the primary concentrator. The concentrated light beam passes through the infrared filter 130, which selectively blocks infrared radiation while transmitting visible wavelengths. The filtered light then passes through the plano-concave lens 140, which optimizes the beam characteristics for transmission through the fiber optic bundle 150. The fiber optic bundle 150 conducts the visible light to the distributing lens 160, which disperses illumination into the interior space.

The artificial lighting pathway operates in parallel through the electronic controller. The sensor 170 continuously monitors ambient light conditions and interfaces with the electrical supply. When natural light levels fall below predetermined thresholds, the sensor 170 triggers activation of LED illumination sources. The LED output is integrated with the natural lighting through the distributing lens 160, maintaining consistent illumination levels in the target space. This dual-pathway configuration enables the system 100 to provide uninterrupted lighting service under varying environmental conditions.

In the system 100, the process flow incorporates multiple feedback mechanisms for system optimization. The sensor 170 samples light levels at 10 Hz frequency, enabling real-time adjustment of LED intensity to complement available natural light. The infrared filter 130 and the plano-concave lens 140 maintain optimal positional relationships from the Fresnel lens 120, providing optimal optical performance throughout the transmission pathway. The heat sink 156 provides continuous thermal management of the fiber optic bundle 150, maintaining stable operation during periods of maximum solar concentration.

Table 1 (below) outlines the materials and properties of the components that are used in the optical and thermal management of the system 100, which shows the type, material, thickness, refractive index (n), density (φ, specific heat capacity for a constant pressure (Cₚ), and thermal conductivity (k) for each component that are being used in the model. In one or more embodiments, the thicknesses range from 20% below the value listed to 20% above the value listed.

TABLE 1
Material and properties of each component

| Component | Type | Material | Thickness | n | ρ[kg/m³] | Cₚ[J/(kg · K)] | k[W/(m · K)] |
|---|---|---|---|---|---|---|---|
| Lens | Fresnel | PMMA | 6 mm | 1.49 | 1190 | 1420 | 0.25 |
| | Lens | | | | | | |
| | Infrared | Borofloat 33 | 3.3 mm | 1.47 | 2200 | 830 | 1.2 |
| | Filter | | | | | | |
| | Lens | | | | | | |
| | Plano- | N-BK7 | 5.241 mm | 1.519 | 2510 | 858 | 1.114 |
| | Concave | | | | | | |
| | Lens | | | | | | |
| Fiber Optic | Core | PMMA | 1.475 mm | 1.49 | 1190 | 1420 | 0.25 |
| Bundle | Cladding | Fluorine Polymer | 0.025 mm | 1.402 | 2200 | 1050 | 0.24 |
| | Coating | Acrylate | 0.51 mm | 1.49 | 1180 | 2 | 0.5 |
| | Jacket | PVC | 1 mm | 1.54 | 1760 | 59.03 | 0.1 |
| Heat Sink | Circular | Aluminum alloy | 5 m | 1.10 | 2700 | 900 | 200 |
| | Heat Sink | 6060 | | | | | |
| Thermal | Thermal | DOWSIL ™ TC- | 1 mm | 4.00 | 3500 | 1500 | 6 |
| interface | Gel | 4060 (silicone) | | | | | |
| material | | | | | | | |

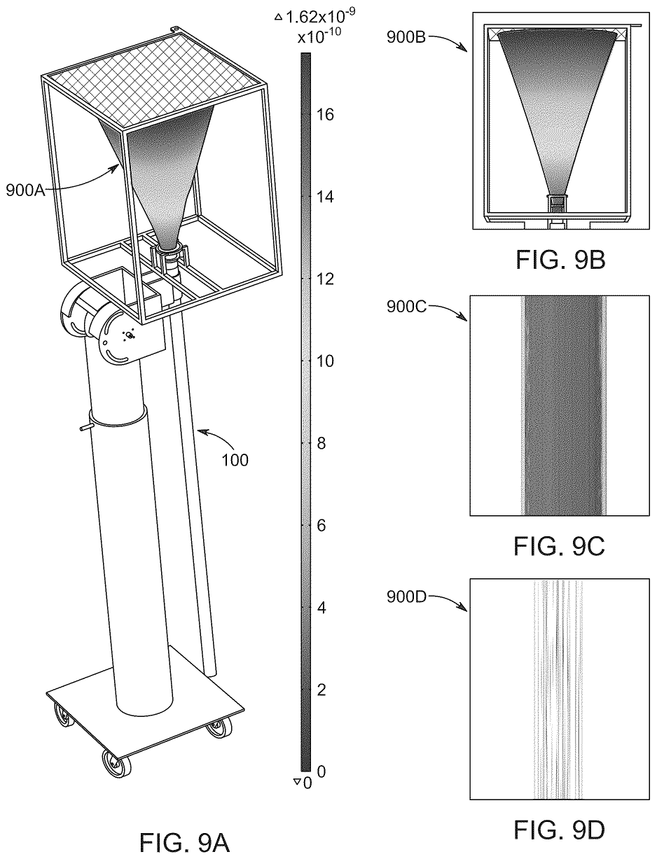

FIG. 9A-9D illustrate various views of the light transmission characteristics of the system 100. FIG. 9B shows the system 100 with the light concentration pathway depicted by the conical gradient (as represented by reference numeral 900A) from the Fresnel lens 120 through the optical components. FIG. 9C illustrates a cross-sectional view (as represented by reference numeral 900B) of the fiber optic bundle 150, showing the transmission path of light through the exterior portion. FIG. 9D provides a detailed view (as represented by reference numeral 900C) of a single optical fiber 152 within the bundle, demonstrating the internal light propagation characteristics. FIG. 9A presents a complete system view showing a color gradient visualization (as represented by reference numeral 900D) demonstrating the progressive concentration of light from the Fresnel lens 120 through the optical components, with the intensity scale ranging from 0 to 16×10⁻¹⁰ W/m². The visualization confirms the uniform distribution of concentrated light through the precisely aligned optical pathway of system 100.

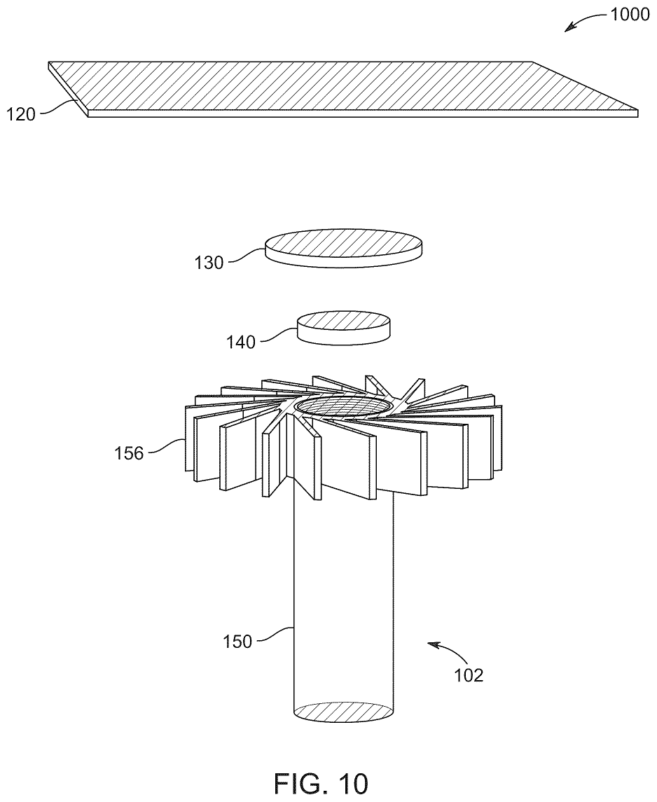

FIG. 10 illustrates an optical model (as represented by reference numeral 1000) of the optical boundary conditions for the system 100, depicting the light interaction pathway through the optical components. The optical model 1000 shows the Fresnel lens 120, the infrared filter 130, the plano-concave lens 140, and the fiber optic bundle 150 with the heat sink 156. Freezing surfaces are marked by the lined areas. The optical dispersion model utilizes air as the dispersion medium with an exterior domain temperature maintained at 20 °C, operating across a wavelength range of 0 to 2500 nanometers. The Fresnel lens 120 receives illumination from 15,000 incident rays with local normal irradiance varying between 0 W/m² and 1100.952 W/m² at the inlet surface. The model implements freezing surface conditions with ray deposited power principles at multiple interaction points, including the interface between the Fresnel lens 120 and the infrared filter 130, between the infrared filter 130 and the plano-concave lens 140, and at both the exterior end 154a and the interior end 154b interfaces of the fiber optic bundle 150. The heat sink 156 surrounding the fiber optic bundle 150 maintains thermal stability while the freezing surface conditions lead to accurate modeling of intensity conversion at each optical interface. The exterior domain maintains consistent refractive index and absorption coefficient values of 1 and 0 respectively, enabling precise simulation of light propagation through the complete optical pathway.

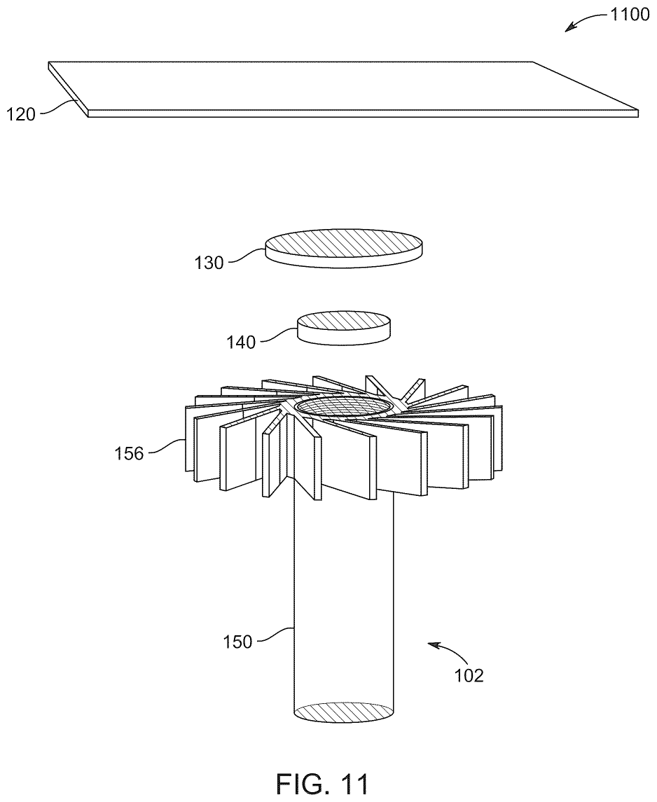

FIG. 11 depicts a thermal model (as represented by reference numeral 1100) for boundary conditions of the system 100, illustrating the heat transfer analysis framework across the optical components. Freezing surfaces are marked by the lined areas. The model incorporates ambient conditions of 20 °C and 1 atmosphere pressure, with freezing surface conditions implemented at multiple interface points. The thermal analysis encompasses both heat flux and surface-to-ambient radiation for components positioned below the Fresnel lens 120, including the infrared filter 130, the plano-concave lens 140, and the fiber optic bundle 150 with the integrated heat sink 156. The system 100 maintains a convection heat transfer coefficient of 15 W/m²·K and implements a surface emission coefficient of 0.92 across all component surfaces. A designated heat boundary source is established at the fiber optic bundle 150, facilitating thermal energy transfer from the optical model to the solid-state heat transfer analysis. Each interface, marked as a freezing surface in the diagram, enables precise control and analysis of heat distribution throughout the optical pathway, with the heat sink 156 providing active thermal management for the fiber optic bundle 150.

The system 100 for sunlight redistribution of the present disclosure provides enhanced illumination capabilities through integration of optical components and thermal management features. The system 100 achieves multiple performance improvements through coordinated component operation. The system 100 implements specific positioning of the infrared filter 130, the plano-concave lens 140, and the fiber optic bundle 150 from the Fresnel lens 120, enabling optimized light transmission while maintaining thermal stability. The precise geometric relationships between the Fresnel lens 120, the infrared filter 130, and the plano-concave lens 140 enable efficient concentration and transmission of visible light while effectively managing thermal loads. Further, in the system 100, the support frame 110 maintains precise positioning of optical components of the optical assembly 102 through integrated adjustment mechanisms, including the adjustable height mechanism 116 and the tilting mechanism 118, providing sustained performance and continuous operation during changing environmental conditions.

The configuration of the fiber optic bundle 150, utilizing polymethyl methacrylate core material and fluoropolymer cladding material, facilitates consistent light transmission across extended distances. The refractive index ratio between the core and cladding materials of the optical fibers 152 establishes efficient light propagation characteristics. The system 100 exhibits enhanced reliability through comprehensive thermal management and precise optical alignment. The integrated heat sink 156 surrounding the exterior end 154a of the fiber optic bundle 150 provides sustained operational stability. The heat sink 156 maintains operational temperatures within specified ranges, while preventing thermal degradation of transmission characteristics in the system 100. Further, the configuration of the distributing lens 160 enables uniform light distribution in interior spaces while minimizing transmission losses. Furthermore, the sensor 170 for ambient light detection enables automated adjustment of supplementary illumination, maintaining uniform light levels under varying environmental conditions.

The modularity and scalability of the system 100 facilitate deployment across diverse architectural environments. Further, the thermal management capabilities provide sustained performance by the system 100 under varying operational conditions. The advanced material selection and geometric relationships between components enable efficient optical performance compared to conventional solutions, particularly in applications requiring high-intensity light transmission over extended distances. The integration of supplementary illumination capabilities provides consistent performance across varying environmental conditions, while the thermal management features protect components of the system 100 during sustained operation.

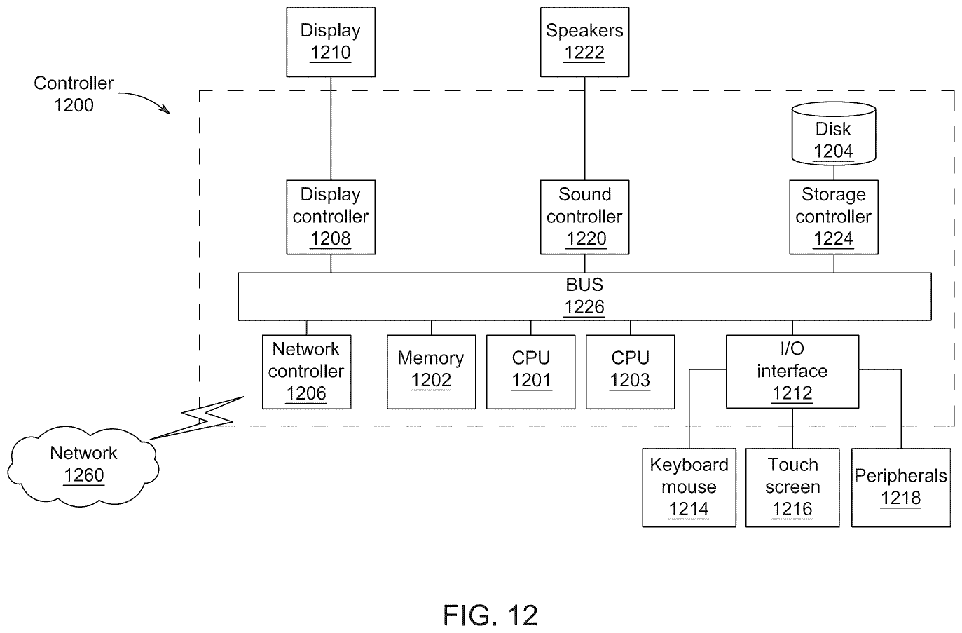

Next, further details of the hardware description of a computing environment according to exemplary embodiments is described with reference to FIG. 12. In FIG. 12, a controller 1200 described is representative of the electronic controller of the present system 100 to control operations of various electrical components therein for supplementary illumination, in which the controller 1200 is a computing device which includes a CPU 1201 which performs the processes described above/below. The process data and instructions may be stored in memory 1202. These processes and instructions may also be stored on a storage medium disk 1204 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 1201, 1203 and an operating system such as Microsoft Windows 7, Microsoft Windows 8, Microsoft Windows 10, UNIX, Solaris, LINUX, Apple MAC-OS and other systems known to those skilled in the art.

The hardware elements in order to achieve the computing device may be realized by various circuitry elements, known to those skilled in the art. For example, CPU 1201 or CPU 1203 may be a Xenon or Core processor from Intel of America or an Opteron processor from AMD of America, or may be other processor types that would be recognized by one of ordinary skill in the art. Alternatively, the CPU 1201, 1203 may be implemented on an FPGA, ASIC, PLD or using discrete logic circuits, as one of ordinary skill in the art would recognize. Further, CPU 1201, 1203 may be implemented as multiple processors cooperatively working in parallel to perform the instructions of the inventive processes described above.

The computing device in FIG. 12 also includes a network controller 1206, such as an Intel Ethernet PRO network interface card from Intel Corporation of America, for interfacing with network 1260. As can be appreciated, the network 1260 can be a public network, such as the Internet, or a private network such as an LAN or WAN network, or any combination thereof and can also include PSTN or ISDN sub-networks. The network 1260 can also be wired, such as an Ethernet network, or can be wireless such as a cellular network including EDGE, 3G, 4G and 5G wireless cellular systems. The wireless network can also be WiFi, Bluetooth, or any other wireless form of communication that is known.

The computing device further includes a display controller 1208, such as a NVIDIA GeForce GTX or Quadro graphics adaptor from NVIDIA Corporation of America for interfacing with display 1210, such as a Hewlett Packard HPL2445w LCD monitor. A general purpose I/O interface 1212 interfaces with a keyboard and/or mouse 1214 as well as a touch screen panel 1216 on or separate from display 1210. General purpose I/O interface also connects to a variety of peripherals 1218 including printers and scanners, such as an OfficeJet or DeskJet from Hewlett Packard.

A sound controller 1220 is also provided in the computing device such as Sound Blaster X-Fi Titanium from Creative, to interface with speakers/microphone 1222 thereby providing sounds and/or music.

The general purpose storage controller 1224 connects the storage medium disk 1204 with communication bus 1226, which may be an ISA, EISA, VESA, PCI, or similar, for interconnecting all of the components of the computing device. A description of the general features and functionality of the display 1210, keyboard and/or mouse 1214, as well as the display controller 1208, storage controller 1224, network controller 1206, sound controller 1220, and general purpose I/O interface 1212 is omitted herein for brevity as these features are known.

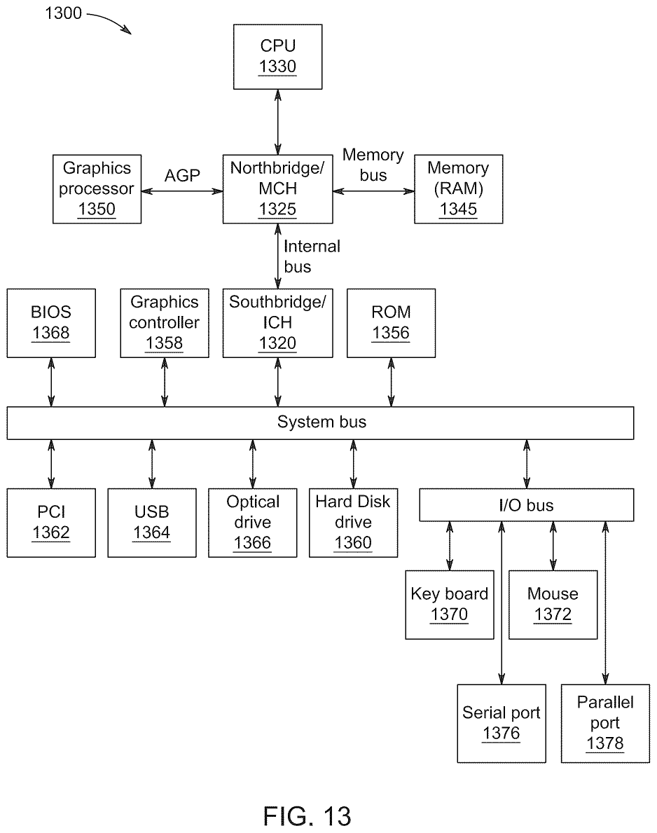

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 13.

FIG. 13 shows a schematic diagram of a data processing system, according to certain embodiments, for performing the functions of the exemplary embodiments. The data processing system is an example of a computer in which code or instructions implementing the processes of the illustrative embodiments may be located.

In FIG. 13, data processing system 1300 employs a hub architecture including a north bridge and memory controller hub (NB/MCH) 1325 and a south bridge and input/output (I/O) controller hub (SB/ICH) 1320. The central processing unit (CPU) 1330 is connected to NB/MCH 1325. The NB/MCH 1325 also connects to the memory 1345 via a memory bus, and connects to the graphics processor 1350 via an accelerated graphics port (AGP). The NB/MCH 1325 also connects to the SB/ICH 1320 via an internal bus (e.g., a unified media interface or a direct media interface). The CPU Processing unit 1330 may contain one or more processors and even may be implemented using one or more heterogeneous processor systems.

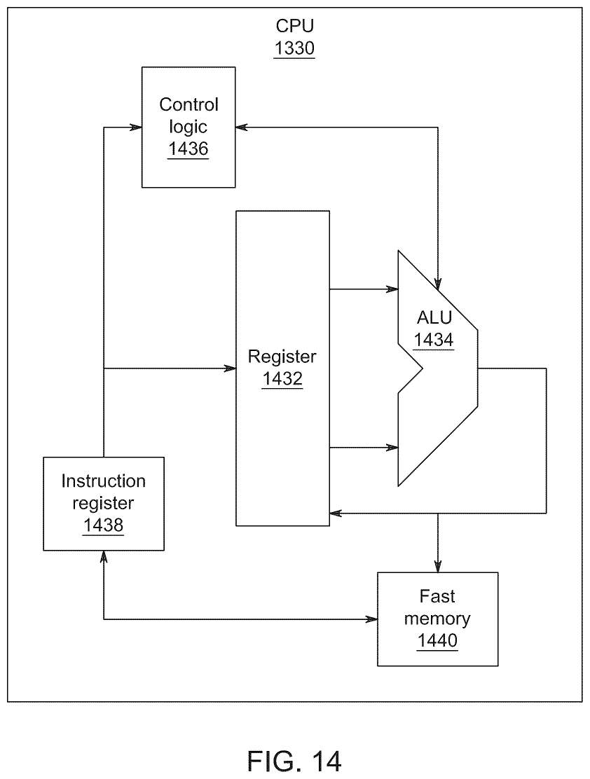

For example, FIG. 14 shows one implementation of CPU 1330. In one implementation, the instruction register 1438 retrieves instructions from the fast memory 1440. At least part of these instructions are fetched from the instruction register 1438 by the control logic 1436 and interpreted according to the instruction set architecture of the CPU 1330. Part of the instructions can also be directed to the register 1432. In one implementation the instructions are decoded according to a hardwired method, and in another implementation the instructions are decoded according a microprogram that translates instructions into sets of CPU configuration signals that are applied sequentially over multiple clock pulses. After fetching and decoding the instructions, the instructions are executed using the arithmetic logic unit (ALU) 1434 that loads values from the register 1432 and performs logical and mathematical operations on the loaded values according to the instructions. The results from these operations can be feedback into the register and/or stored in the fast memory 1440. According to certain implementations, the instruction set architecture of the CPU 1330 can use a reduced instruction set architecture, a complex instruction set architecture, a vector processor architecture, a very large instruction word architecture. Furthermore, the CPU 1330 can be based on the Von Neuman model or the Harvard model. The CPU 1330 can be a digital signal processor, an FPGA, an ASIC, a PLA, a PLD, or a CPLD. Further, the CPU 1330 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 13, the data processing system 1300 can include that the SB/ICH 1320 is coupled through a system bus to an I/O Bus, a read only memory (ROM) 1356, universal serial bus (USB) port 1364, a flash binary input/output system (BIOS) 1368, and a graphics controller 1358. PCI/PCIe devices can also be coupled to SB/ICH 1388 through a PCI bus 1362.

The PCI devices may include, for example, Ethernet adapters, add-in cards, and PC cards for notebook computers. The Hard disk drive 1360 and CD-ROM 1366 can use, for example, an integrated drive electronics (IDE) or serial advanced technology attachment (SATA) interface. In one implementation the I/O bus can include a super I/O (SIO) device.

Further, the hard disk drive (HDD) 1360 and optical drive 1366 can also be coupled to the SB/ICH 1320 through a system bus. In one implementation, a keyboard 1370, a mouse 1372, a parallel port 1378, and a serial port 1376 can be connected to the system bus through the I/O bus. Other peripherals and devices that can be connected to the SB/ICH 1320 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry or based on the requirements of the intended back-up load to be powered.

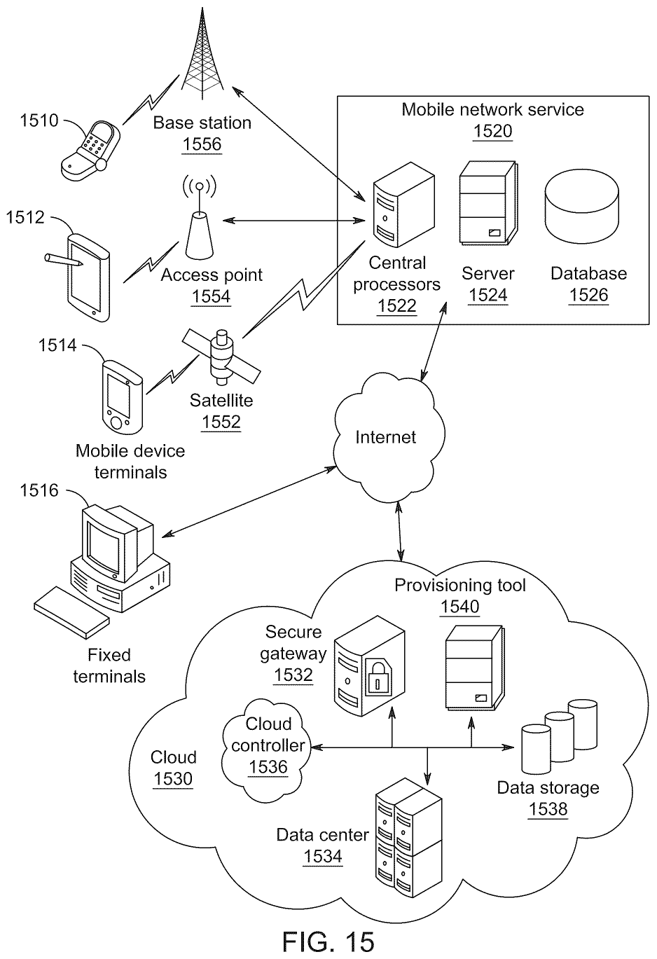

The functions and features described herein may also be executed by various distributed components of a system. For example, one or more processors may execute these system functions, wherein the processors are distributed across multiple components communicating in a network. The distributed components may include one or more client and server machines, such as cloud 1530 including a cloud controller 1536, a secure gateway 1532, a data center 1534, data storage 1538 and a provisioning tool 1540, and mobile network services 1520 including central processors 1522, a server 1524 and a database 1526, which may share processing, as shown by FIG. 15, in addition to various human interface and communication devices (e.g., display monitors 1516, smart phones 1510, tablets 1512, personal digital assistants (PDAs) 1514). The network may be a private network, such as a LAN, satellite 1552 or WAN 1554, or be a public network, may such as the Internet. Input to the system may be received via direct user input and received remotely either in real-time or as a batch process. Additionally, some implementations may be performed on modules or hardware not identical to those described. Accordingly, other implementations are within the scope that may be claimed.

While specific embodiments of the disclosure have been described, it should be understood that various modifications and alternatives may be implemented without departing from the spirit and scope of the disclosure. For example, different cellular automata rules or encryption algorithms could be employed, or alternative feature extraction and face recognition techniques could be integrated into the system.

The above-described hardware description is a non-limiting example of corresponding structure for performing the functionality described herein.

Numerous modifications and variations of the present disclosure are possible in light of the above teachings. It is therefore to be understood that within the scope of the appended claims, the disclosure may be practiced otherwise than as specifically described herein.

1. A system for sunlight redistribution comprising:
a light concentrating Fresnel lens configured to direct light to an infrared filter;
the infrared filter disposed above a plano-concave lens;
the plano-concave lens disposed above a fiber optic bundle comprising a plurality of optical fibers, an exterior end, and an interior end;
a distributing lens disposed below the fiber optic bundle which transfers visible light to a distributing lens; and
the distributing lens which distributes visible light to an interior space,
wherein the exterior end receives visible light from the plano-concave lens and the interior end transmits visible light to the distributing lens,
wherein the optical fibers comprise a core material and cladding material,
wherein the refractive index ratio of the core material to cladding material is in a range from 1.05 to 1.075,
wherein the infrared filter is positioned 403 to 413 mm from the Fresnel lens,
wherein the plano-concave lens is positioned 428 to 438 mm from the Fresnel lens, and
wherein the exterior end of the fiber optic bundle is positioned 458 to 468 mm from the Fresnel lens.

2. The system of claim 1, wherein the Fresnel lens has a diameter in a range from 340 to 360 mm.

3. The system of claim 2, wherein the Fresnel lens has a diameter in a range from 345 to 355 mm.

4. The system of claim 3, wherein the Fresnel lens has a diameter of 350 mm.

5. The system of claim 1, wherein the infrared filter has a diameter in a range from 45 to 55 mm.

6. The system of claim 4, wherein the infrared filter has a diameter in a range from 47 to 53 mm.

7. The system of claim 6, wherein the infrared filter has a diameter of 50 mm.

8. The system of claim 1, wherein the plano-concave lens has a diameter in a range from 27 to 33 mm.

9. The system of claim 8, wherein the plano-concave lens has a diameter in a range from 29 to 31 mm.

10. The system of claim 9, wherein the plano-concave lens has a diameter of 30 mm.

11. The system of claim 1, wherein the fiber optic bundle has a diameter in a range from 27 to 33 mm.

12. The system of claim 11, wherein the fiber optic bundle has a diameter in a range from 29 to 31 mm.

13. The system of claim 12, wherein the fiber optic bundle has a diameter of 30 mm.

14. The system of claim 1, wherein the infrared filter is positioned 408 mm from the Fresnel lens.

15. The system of claim 1, wherein the plano-concave lens is positioned 433 mm from the Fresnel lens.

16. The system of claim 1, wherein the fiber optic bundle is positioned 460 to 466 mm from the Fresnel lens.

17. The system of claim 1, wherein the fiber optic bundle is positioned 463 mm from the Fresnel lens.

18. The system of claim 1, further comprising a sensor which detects ambient light levels.

19. The system of claim 1, wherein the system further comprises a heat sink surrounding the exterior end of the fiber optic bundle.

20. The system of claim 1, wherein the core material is polymethyl methacrylate and the cladding material is a fluoropolymer.
